(19) United States
(12) Patent Application Publication
(10) Pub. No.: US 2012/0268617 A1
(43) Pub. Date: Oct. 25, 2012

(54) ELECTRONIC CAMERA

(75) Inventor: Tadaaki ISHIKAWA, Yokohama-shi (JP)

(73) Assignee: NIKON CORPORATION, Tokyo (JP)

(21) Appl. No.: 13/460,099

(22) Filed: Apr. 30, 2012

Related U.S. Application Data
(63) Continuation of application No. PCT/JP2010/006887, filed on Nov. 25, 2010.

(30) Foreign Application Priority Data
Nov. 26, 2009 (JP) 2009-268247

(51) Int. Cl. H04N 5/225; H04N 5/235

(52) U.S. Cl. 348/221.1; 348/220.1; 348/E05.024

(57) ABSTRACT

An electronic camera includes an imaging section, an imaging controlling section, and an image processing section. The imaging section performs imaging of a subject image. The imaging controlling section makes the imaging section perform a photographing of moving image at a first frame rate at a time of performing moving image photographing, and makes the imaging section obtain images at a second frame rate which is a frame rate higher than the first frame rate when receiving an instruction of still image recording at the time of performing the moving image photographing. The image processing section generates a still image for recording by superimposing a plurality of images at the second frame rate.

### CROSS REFERENCE TO RELATED APPLICATION

This application is a continuation application of International Application No. PCT/JP2010/006887, filed on Nov. 25, 2010, designating the U.S., in which the International Application claims a priority date of Nov. 26, 2009, based on prior filed Japanese Patent Application No. 2009-268247, the entire contents of which are incorporated herein by reference.

### BACKGROUND

1. Field

The present application relates to an electronic camera having a moving image photographing function.

2. Description of the Related Art

Conventionally, there has been proposed an electronic camera capable of obtaining a still image for recording, during a moving image photographing (refer to Patent Document 1: Japanese Unexamined Patent Application Publication No. 2006-109405, for example). In the technique disclosed in Patent Document 1, an exposure time at a time of photographing a still image has been set to be shorter than an exposure time at a time of photographing a moving image, in order to prevent an image blur at the time of photographing the still image.

However, in the technique disclosed in Patent Document 1, there arises a problem that an exposure amount becomes insufficient in accordance with the reduction in the exposure time at the time of photographing the still image.

### SUMMARY

In view of the above-described circumstances, the present invention has a proposition to provide an electronic camera capable of obtaining a still image for recording with a more favorable exposure while suppressing an image blur when the still image is obtained during a moving image photographing.

### BRIEF DESCRIPTION OF THE DRAWINGS

FIG. 1 is a sectional view of an electronic camera 1.

FIG. 2 is a block diagram illustrating an internal configuration of the electronic camera 1 illustrated in FIG. 1.

FIG. 3 is diagrams schematically explaining processing of an imaging controlling section 21a.

FIG. 4 is a flow chart illustrating an example of a case where a still image is obtained during a moving image photographing.

FIG. 5 is diagrams schematically explaining an example in processing of frame synthesis.

FIG. 6 is diagrams schematically explaining another example in the processing of frame synthesis.

FIG. 7 is a flow chart illustrating a subroutine of still image generation.

FIG. 8 is diagrams schematically explaining an example in processing of still image generation.

FIG. 9 is diagrams schematically explaining another example in the processing of still image generation.

FIG. 10 is diagrams schematically explaining another example in the processing of still image generation and frame synthesis.

### DETAILED DESCRIPTION OF THE EMBODIMENT

Hereinafter, an embodiment of the present invention will be described in detail based on the drawings. Note that “moving image photographing mode” to be explained in the present embodiment is a photographing mode capable of obtaining a still image for recording, during a moving image photographing (including a moving image recording) (details will be described later).

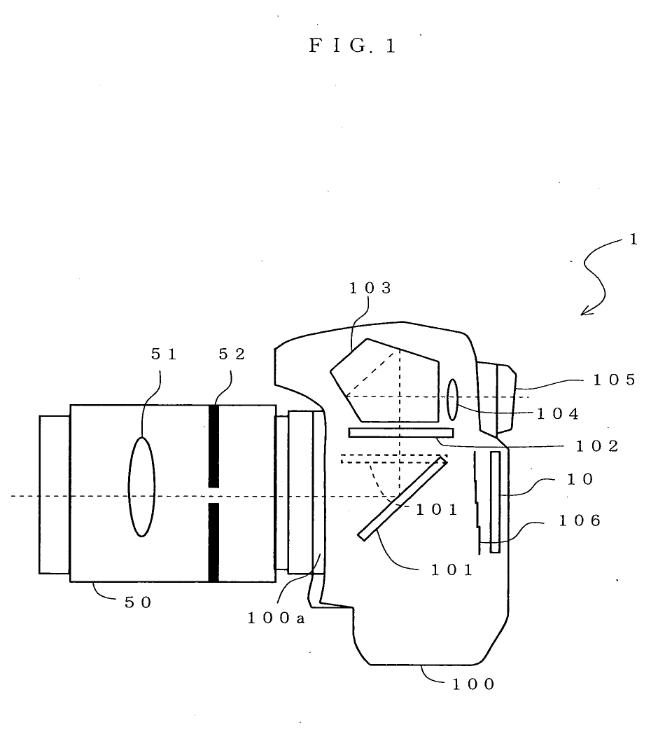

FIG. 1 is a sectional view of an electronic camera 1. The electronic camera 1 is an electronic camera of single lens reflex type, for example, and has a camera body 100 and a photographic lens unit 50. The photographic lens unit 50 is detachably attached to a lens mount 100a formed on a front surface of the camera body 100, in order to introduce a subject light into the camera body 100. Note that when the photographic lens unit 50 is attached, the camera body 100 and the photographic lens unit 50 are electrically connected via a contact of the lens mount 100a.

The photographic lens unit 50 has a lens system 51 and an aperture 52. The lens system 51 is formed of a plurality of pieces of lenses including a focus lens that focuses on the subject and a zoom lens for zooming the subject image. Here, for convenience of explanation, the lens system 51 is illustrated by one piece of lens.

The camera body 100 has a quick return mirror 101, a viewfinder screen 102, a penta-dach prism 103, an eyepiece lens 104, an optical viewfinder 105, a mechanical shutter 106 and an imaging sensor 10.

The quick return mirror 101 is pivotally provided on an optical axis indicated by a dotted line in the drawing. When a photographing of subject is not conducted, the quick return mirror 101 is disposed, by a mirror controlling section (not illustrated), at a position diagonal to the optical axis. In this case, the quick return mirror 101 receives a subject light incident on the camera body 100 through the lens system 51, and reflects the subject light to introduce the light into the viewfinder screen 102.

On the other hand, at a time of performing imaging in which the imaging of the subject is conducted, the quick return mirror 101 pivots to retreat to the outside of a photographing optical path (position indicated by a dotted line in the drawing). Further, a subject light incident on the camera body 100 from the subject is introduced into the imaging sensor 10.

When the imaging is not conducted by the imaging sensor 10, the viewfinder screen 102 diffuses the subject light introduced by the quick return mirror 101, and introduces the diffused subject light into the penta-dach prism 103. The penta-dach prism 103 reflects the subject light diffused by the viewfinder screen 102 to introduce the light into the eyepiece lens 104.

The eyepiece lens 104 forms an image of the subject light introduced by the penta-dach prism 103, as a subject image. A person who performs photographing can determine a composition of the subject, a frame and so on, by looking, through the optical viewfinder 105, the subject image formed by the eyepiece lens 104.

The mechanical shutter 106 includes an open/close type shutter curtain, and switches a light-shielding state in which the incident light on the imaging sensor 10 is shielded, and a non-light-shielding state in which the incident light is made to reach the imaging sensor 10, by opening/closing the shutter curtain.

The imaging sensor 10 performs imaging of the subject image to obtain an image. Here, the imaging sensor 10 may be an imaging sensor of a CCD (Charge Coupled Device) type or a CMOS (Complementary Metal-Oxide Semiconductor) type. In the present embodiment, the imaging sensor of CMOS type is adopted. On an imaging area of the imaging sensor 10, three types of color filters of R (red), G (green), and B (blue) are arranged in a Bayer pattern, as an example.

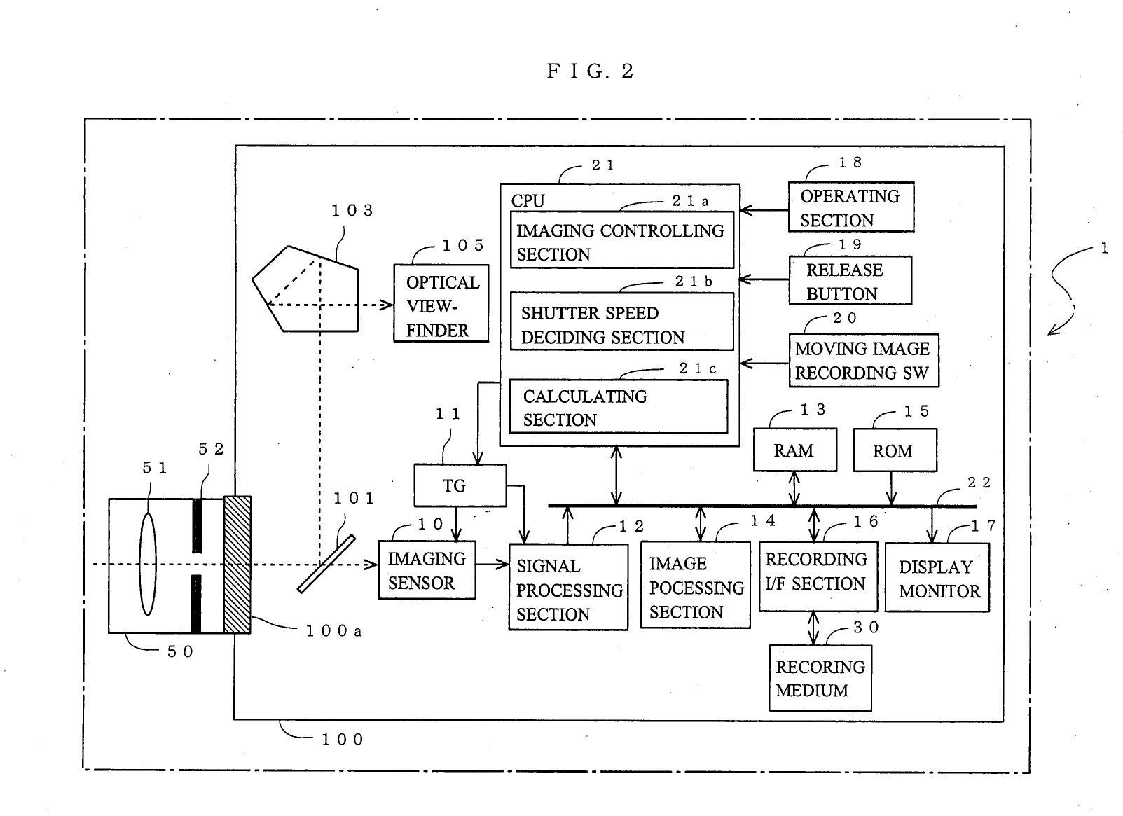

FIG. 2 is a block diagram illustrating an internal configuration of the electronic camera 1 illustrated in FIG. 1. As described above, the electronic camera 1 has the camera body 100 and the photographic lens unit 50. Note that in FIG. 2, the illustration of the viewfinder screen 102, the eyepiece lens 104, the mechanical shutter 106 and the like illustrated in FIG. 1 is omitted, for convenience of explanation.

The camera body 100 includes the quick return mirror 101, the imaging sensor 10, a timing generator (referred to as “TG”, hereinafter) 11, a signal processing section 12, a RAM (Random Access Memory) 13, an image processing section 14, a ROM (Read Only Memory) 15, a recording interface section (referred to as “recording I/F section”, hereinafter) 16, a display monitor 17, an operating section 18, a release button 19, a moving image recording switch (referred to as “moving image recording SW”, hereinafter) 20, a CPU (Central Processing Unit) 21, a bus 22, and the lens mount 100a.

Among the above, the signal processing section 12, the RAM 13, the image processing section 14, the ROM 15, the recording I/F section 16, the display monitor 17 and the CPU 21 are mutually connected via the bus 22.

The TG 11 transmits, in accordance with an instruction from the CPU 21, a driving signal toward each of the imaging sensor 10 and the signal processing section 12, thereby controlling driving timings of both of the imaging sensor 10 and the signal processing section 12.

The signal processing section 12 has an analog front end circuit (AFE) that performs analog signal processing on an image signal output by the imaging sensor 10, and a digital front end circuit (DFE) that performs digital signal processing on the image signal after being subjected to the analog signal processing in the AFE. The signal processing section 12 performs gain adjustment, A/D conversion and the like of the image signal, for example. The image signal output by the signal processing section 12 is temporarily recorded in the RAM 13 as image data. The RAM 13 has a function as a frame memory that temporarily records the image data.

The image processing section 14 reads the image data recorded in the RAM 13, and performs various types of image processing (gradation conversion processing, edge enhancement processing, white balance processing, YC conversion processing and the like).

Further, the image processing section 14 superimposes a plurality of images obtained at a second frame rate, which is a frame rate higher than a first frame rate for moving image photographing, thereby generating a still image for recording. Further, the image processing section 14 superimposes the plurality of images obtained at the second frame rate, in accordance with a time interval of the first frame rate, to thereby convert the plurality of images into a moving image at the first frame rate. Details will be described later.

Further, at the time of recording the moving image, the image processing section 14 performs, on the image data, compression processing in a predetermined image format (Motion-JPEG (Joint Photographic Experts Group) or the like, for example).

The ROM 15 is a nonvolatile memory that previously stores a program for controlling the electronic camera 1, and the like. On the recording I/F section 16, a connector (not illustrated) for connecting a recording medium 30 which is detachable is formed. Further, the recording I/F section 16 performs, in accordance with an instruction from the CPU 21, recording processing of the still image and the moving image and the like, by accessing to the recording medium 30 connected to the connector. The recording medium 30 is a nonvolatile memory card, for example. In FIG. 2, the recording medium 30 after being connected to the connector is illustrated.

The display monitor 17 displays, in accordance with an instruction from the CPU 21, the still image, the moving image, an operation menu of the electronic camera 1 or the like, for example. As the display monitor 17, a liquid crystal monitor or the like can be appropriately selected to be used.

The operating section 18 has, for example, a command dial for command selection, a power button and the like. Further, the operating section 18 receives an instruction input for operating the electronic camera 1. Further, the operating section 18 receives a selection input of “still image photographing mode” or “moving image photographing mode” through the command dial, for example.

Here, at a time of performing imaging in the “still image photographing mode”, the quick return mirror 101 pivots to retreat to the outside of the photographing optical path. At this time, a subject light incident on the camera body 100 from a subject is introduced into the imaging sensor 10 by opening the mechanical shutter 106. Accordingly, the imaging sensor 10 can obtain one still image. In the “moving image photographing mode”, the quick return mirror 101 pivots to retreat to the outside of the photographing optical path, and the mechanical shutter 106 becomes in an open state. Accordingly, the imaging sensor 10 can continuously obtain a plurality of images at a predetermined frame rate.

The release button 19 is a button that receives an instruction input of a full-depressing operation (still image recording). The moving image recording SW 20 is a switch for performing moving image recording in the “moving image photographing mode”. When the moving image recording SW 20 is turned on by the person who performs photographing, the CPU 21 starts the moving image recording.

Note that in the “moving image photographing mode”, when the CPU 21 receives the instruction input of the full-depressing operation of the release button 19 during the moving image photographing (moving image recording), the CPU 21 obtains a still image for recording. Details will be described later.

The CPU 21 is a processor that performs comprehensive control of the electronic camera 1. The CPU 21 executes the program previously stored in the ROM 15, thereby controlling various types of calculation processing and respective sections of the electronic camera 1.

Further, the CPU 21 also functions as an imaging controlling section 21a, a shutter speed deciding section 21b, and a number-of-images-to-be-synthesized calculating section 21c (hereinafter referred to as the calculating section 21c).

The imaging controlling section 21a makes the imaging sensor 10 obtain a plurality of images (frames) at a first frame rate used for the moving image photographing. Here, in the present embodiment, the first frame rate is set to 30 fps (frame/second), as an example. Further, when the CPU 21 receives the instruction input of the still image recording during the moving image photographing (including the moving image recording), the imaging controlling section 21a switches the frame rate from the first frame rate to the second frame rate. Further, the imaging controlling section 21a makes the imaging sensor 10 obtain a plurality of images (frames) at the second frame rate, whose number corresponds to the number of images to be photographed. Here, in the present embodiment, the second frame rate is set to 120 fps (frame/second) as an example, for convenience of explanation. Note that when the obtainment of images whose number corresponds to the number of images to be photographed at the second frame rate is terminated, the imaging controlling section 21a switches the frame rate from the second frame rate to the first frame rate. Accordingly, the imaging controlling section 21a makes the imaging sensor 10 obtain a plurality of images at the first frame rate again.

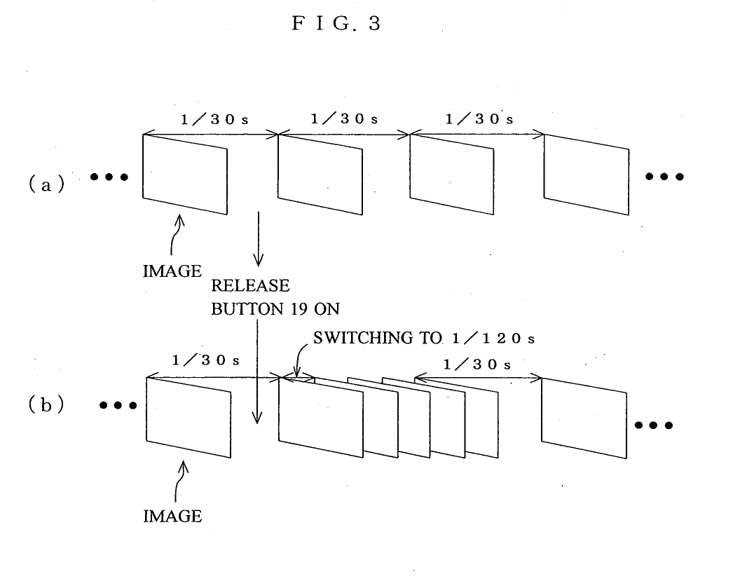

FIG. 3 is diagrams schematically explaining processing of the imaging controlling section 21a. The imaging controlling section 21a makes the imaging sensor 10 obtain images at a time interval of 1/30 (second), via the TG 11 ((a) of FIG. 3). When the CPU 21 detects the depression of release button 19 under this state, the imaging controlling section 21a makes the imaging sensor 10 obtain four images (frames) at a time interval of 1/120 (second) as an example, via the TG 11 ((b) of FIG. 3).

The shutter speed deciding section 21b decides, based on a brightness of image obtained at the first frame rate, a shutter speed for obtaining a still image. Concretely, at first, the CPU 21 sequentially calculates an exposure amount of correct exposure (AE: Auto Exposure), based on a brightness signal of the image obtained at the first frame rate. The CPU 21 overwrites the value of the exposure amount in the RAM 13. Subsequently, the shutter speed deciding section 21b decides the shutter speed based on the latest exposure amount calculated by the CPU 21. Note that in the present embodiment, an aperture value and an imaging sensitivity are fixed, for easier understanding of the explanation. Further, the shutter speed deciding section 21b may also decide the shutter speed based on an average value of the exposure amounts calculated by the CPU 21.

The calculating section 21c calculates, based on the shutter speed, the number of images to be synthesized of the images at the second frame rate required for generating the still image. For example, if the shutter speed is 1/30 (second), the calculating section 21c calculates the number of images to be synthesized as four, based on a relation of 1/120 (second)×4= 1/30 (second). In this case, based on the number of images to be synthesized calculated by the calculating section 21c, the image processing section 14 superimposes four images obtained at the second frame rate, thereby generating one still image. Alternatively, if the shutter speed is 1/15 (second), the calculating section 21c calculates the number of images to be synthesized as eight, based on a relation of 1/120 (second)×8= 1/15 (second). In this case, based on the number of images to be synthesized calculated by the calculating section 21c, the image processing section 14 superimposes eight images obtained at the second frame rate, thereby generating one still image for recording. Note that in the present embodiment, based on a relation of 1/120 (second)×4= 1/30 (second), the image processing section 14 superimposes four images obtained at the second frame rate (120 fps) in accordance with the time interval of the first frame rate (30 fps), thereby converting the images at the second frame rate into a moving image at the first frame rate. Here, the CPU 21 may also decide the number of images to be synthesized at the second frame rate to be superimposed, based on a ratio between the first frame rate and the second frame rate, and a ratio between the exposure amount at the time of the moving image photographing and the exposure amount at the time of obtaining the still image.

Next, an operation of the electronic camera 1 will be described.

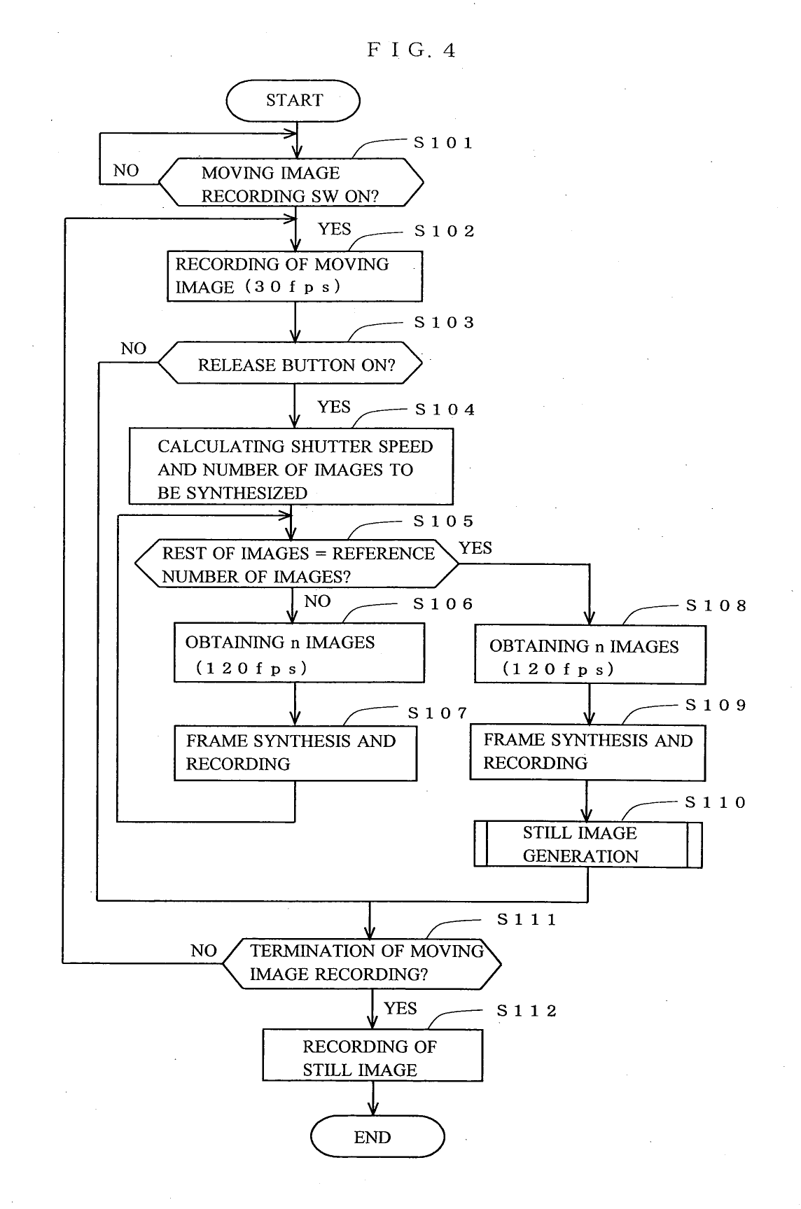

FIG. 4 is a flow chart illustrating an example of a case where a still image is obtained during the moving image photographing. In the explanation hereinbelow, a case where a function of “moving image photographing mode” is set on, will be described. First, after the power of the electronic camera 1 is turned on, when the CPU 21 receives the selection input of the “moving image photographing mode” via the operating section 18, it makes the quick return mirror 101 illustrated in FIG. 1 retreat. Subsequently, the CPU 21 starts processing of the flow chart illustrated in FIG. 4.

Step S101: The CPU 21 checks the presence/absence of the instruction input indicating the start of moving image recording, via the moving image recording SW 20. When the CPU 21 has not yet received the instruction input indicating the start of moving image recording (step S101: No), it repeatedly conducts the processing in step S101. On the other hand, when the CPU 21 has received the instruction input indicating the start of moving image recording (step S101: Yes), it proceeds to step S102.

Step S102: The CPU 21 starts the moving image recording. Concretely, the imaging controlling section 21a of the CPU 21 transmits the driving signal toward each of the imaging sensor 10 and the signal processing section 12, via the TG 11. Accordingly, the imaging controlling section 21a makes the imaging sensor 10 obtain a plurality of images at the first frame rate. The signal processing section 12 performs the signal processing on image signals of the images obtained by the imaging sensor 10. The image signals output by the signal processing section 12 are temporarily recorded in the RAM 13 as image data. The image processing section 14 reads the image data recorded in the RAM 13, performs the various types of image processing, and then performs the compression processing. Subsequently, the CPU 21 sequentially records the moving images after being subjected to the image processing and the compression processing, in the recording medium 30 via the recording I/F 16.

Further, the image processing section 14 converts the images continuously output by the imaging sensor 10 into brightness signals and color difference signals, through the YC conversion processing. The CPU 21 sequentially calculates the exposure amounts of correct exposure, in accordance with the brightness signals of the images read at the first frame rate, as an example. The CPU 21 overwrites the values of the exposure amounts in the RAM 13.

Step S103: The CPU 21 detects the presence/absence of the instruction input of the full-depressing operation of the release button 19, in parallel with the processing in step S102. When the CPU 21 receives the instruction input of the full-depressing operation (step S103: Yes), it proceeds to step S104. On the other hand, when the CPU 21 does not receive the instruction input of the full-depressing operation (step S103: No), the CPU 21 proceeds to later-described step S111, and when the moving image recording is not terminated (step S111: No), the CPU 21 returns to step S102.

Step S104: The shutter speed deciding section 21b of the CPU 21 decides the shutter speed for obtaining the still image, based on the exposure amount calculated by the CPU 21. Further, the calculating section 21c of the CPU 21 calculates the number of images to be synthesized of the images at the second frame rate, based on the shutter speed.

Step S105: The CPU 21 decrements the previously set number of images to be photographed, each time one image is photographed at the second frame rate, to thereby calculate the number of the rest of the images to be photographed. In the present embodiment, the number of images to be synthesized calculated by the calculating section 21c is set to the number of images to be photographed at the second frame rate. Note that a case where the number of images to be synthesized and the number of images to be photographed are different, will be explained in supplemental matters to embodiment.

Further, the CPU 21 determines whether or not the number of the rest of the images to be photographed is a number of frames (reference number of images) required for converting images into an image at the first frame rate. This is a step of conducting a still image synthesis after performing a frame synthesis of moving image by the image processing section 14.

Note that if the second frame rate is 120 fps, since the first frame rate is 30 fps, the reference number of images is four.

When the number of the rest of the images to be photographed at the second frame rate corresponds to the reference number of images (step S105: Yes), the process proceeds to step S108. On the other hand, when the number of the rest of the images to be photographed at the second frame rate dose not correspond to the reference number of images (step S105: No), the process proceeds to step S106.

Step S106: The imaging controlling section 21a of the CPU 21 transmits the driving signal toward each of the imaging sensor 10 and the signal processing section 12, via the TG 11. Accordingly, the imaging controlling section 21a makes the imaging sensor 10 obtain n (=4) images at the second frame rate. The signal processing section 12 performs the signal processing on image signals of the images obtained by the imaging sensor 10. The image signals output by the signal processing section 12 are temporarily recorded in the RAM 13 as image data.

Step S107: The image processing section 14 superimposes the plurality of images obtained at the second frame rate in accordance with the time interval of the first frame rate, thereby converting the images into a moving image at the first frame rate. Concretely, the image processing section 14 performs processing of adding respective pixel values at the same coordinate in the n (=4) images obtained at the second frame rate, thereby converting the images into one image (frame synthesis). The image after performing the conversion is subjected to the compression processing by the image processing section 14, and then temporarily recorded in the RAM 13. The CPU 21 records the image after being subjected to the compression processing in the recording medium 30 via the recording I/F 16. At this time, while preventing the missing of the images at the first frame rate, the CPU 21 sequentially records the images in the recording medium 30 in time series.

Note that the CPU 21 returns to step S105 to make the image processing section 14 perform the frame synthesis, and to make, in parallel with that, the imaging controlling section 21a perform the processing.

Here, when the number of the rest of the images to be photographed at the second frame rate corresponds to the reference number of images (step S105: Yes), the process proceeds to step S108.

Step S108: The imaging controlling section 21a of the CPU 21 makes the imaging sensor 10 obtain four images at the second frame rate, in a similar manner to step S106. The signal processing section 12 performs the signal processing on image signals of the images obtained by the imaging sensor 10, in a similar manner to step S106. The image signals output by the signal processing section 12 are temporarily recorded in the RAM 13 as image data.

Step S109: The image processing section 14 superimposes the plurality of images obtained at the second frame rate in accordance with the time interval of the first frame rate, thereby converting the images into a moving image at the first frame rate, in a similar manner to step S107. The CPU 21 records the image after being subjected to the compression processing in the recording medium 30 via the recording I/F 16. Here, the processing of frame synthesis will be described concretely by using the drawings.

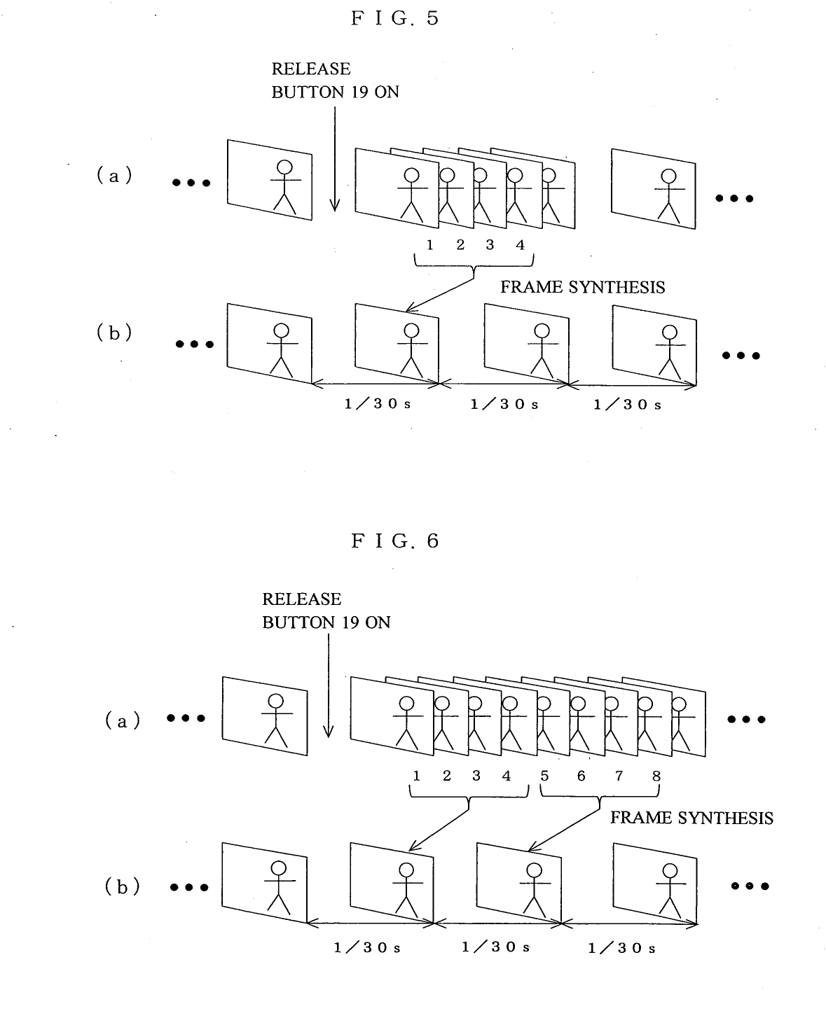

FIG. 5 is diagrams schematically explaining an example in the processing of frame synthesis. FIG. 5 illustrates a case where the shutter speed is set to 1/30 (second). (a) of FIG. 5 is a diagram of explaining the frame synthesis, and, in the drawing, sequence numbers 1 to 4 represent an image group photographed at the second frame rate. In this case, the image processing section 14 synthesizes the image group from the sequence numbers 1 to 4 into one image. Concretely, the image processing section 14 adds pixel values at the same coordinate in the respective images from the sequence numbers 1 to 4. (b) of FIG. 5 represents a state where a moving image at the first frame rate is interpolated by a frame synthesized in accordance with the time interval of 1/30 (second). Accordingly, in the present embodiment, a frame omission of moving image is prevented from occurring even if a still image is obtained during the moving image photographing.

Further, FIG. 6 is diagrams schematically explaining another example in the processing of frame synthesis. FIG. 6 illustrates a case where the shutter speed is set to 1/15 (second). (a) of FIG. 6 is a diagram of explaining the frame synthesis, and, in the drawing, sequence numbers 1 to 8 represent an image group photographed at the second frame rate. In this case, the image processing section 14 synthesizes an image group from the sequence numbers 1 to 4 into one image, and it also synthesizes an image group from the sequence numbers 5 to 8 into one image.

(b) of FIG. 6 represents a state where a moving image at the first frame rate is interpolated by a frame synthesized in accordance with the time interval of 1/30 (second). Accordingly, in the present embodiment, a frame omission of moving image caused by the obtainment of still image is prevented from occurring even if the still image is obtained during the moving image photographing, similar to the case illustrated in (b) of FIG. 5.

Step S110: The CPU 21 executes a subroutine of still image generation. Note that the CPU 21 performs the parallel processing, so that the CPU 21 starts the subroutine of the sill image generation, and it also proceeds to step S111.

Step S111: The CPU 21 determines the presence/absence of the instruction input indicating the termination of moving image recording. When the instruction input indicating the termination of moving image recording is not accepted (step S111: No), the process returns to step S102. On the other hand, when the instruction input indicating the termination of moving image recording is accepted (step S111: Yes), the process proceeds to step S112.

Step S112: The CPU 21 records the image data of the still image temporarily recorded in the RAM 13 in the recording medium 30 via the recording I/F 16. Subsequently, the CPU 21 terminates the processing of the flow chart illustrated in FIG. 4.

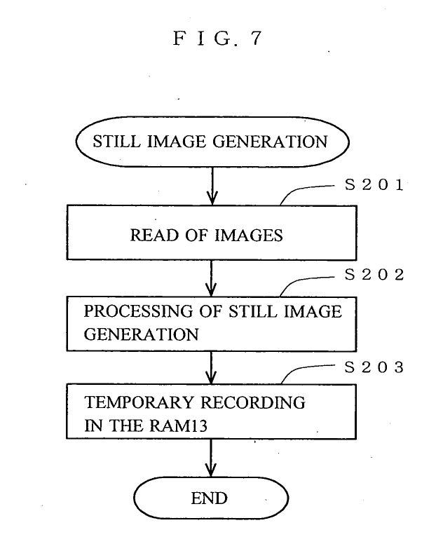

Next, the subroutine will be described. FIG. 7 is a flow chart illustrating the subroutine of the still image generation in step S110 in FIG. 4. Note that since the CPU 21 performs the parallel processing in the processing in step S110 in FIG. 4, the CPU 21 executes the subroutine illustrated in FIG. 7, and it also proceeds to the processing in step S111.

Step S201: The image processing section 14 reads the plurality of images obtained at the second frame rate recorded in the RAM 13.

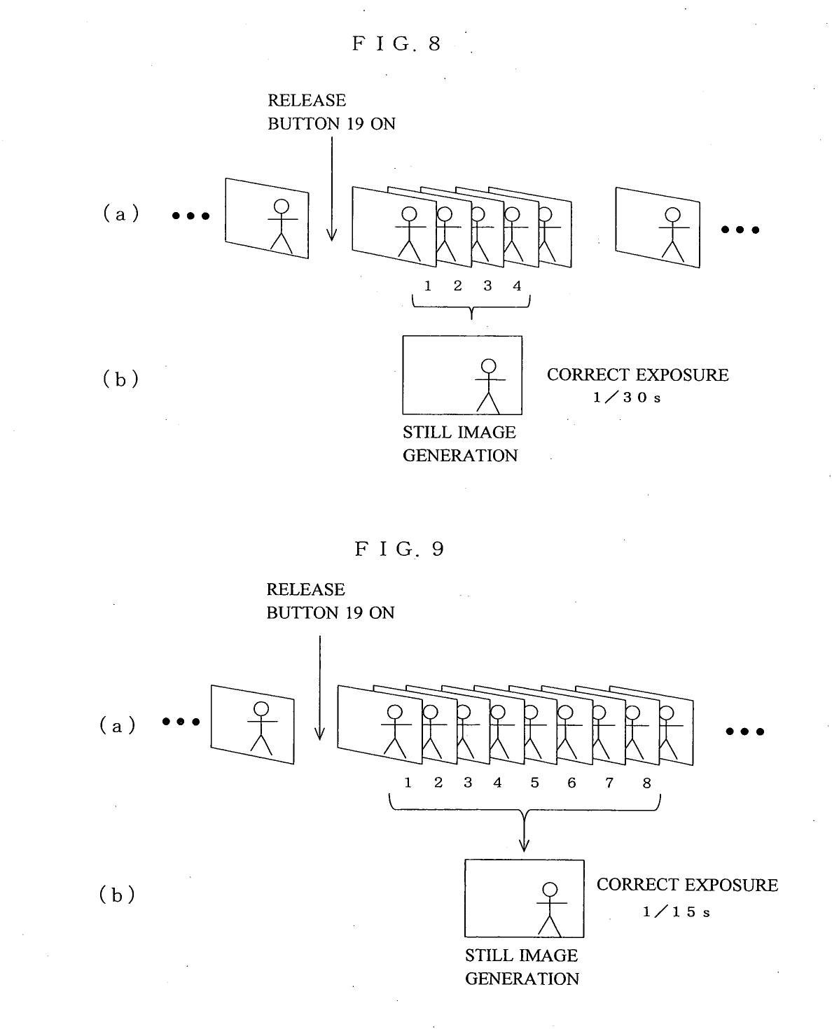

Step S202: The image processing section 14 adds respective pixel values at the same coordinate in a plurality of images, thereby generating one still image. FIG. 8 is diagrams schematically explaining an example in the processing of still image generation. For example, as illustrated in FIG. 8, when the CPU 21 sets the shutter speed to 1/30 (second), the image processing section 14 generates one still image from four images obtained at the second frame rate.

FIG. 9 is diagrams schematically explaining another example in the processing of still image generation. As illustrated in FIG. 9, when the CPU 21 sets the shutter speed to 1/15 (second), the image processing section 14 generates one still image by superimposing eight images obtained at the second frame rate.

As illustrated in FIG. 8 and FIG. 9, the imaging controlling section 21a of the CPU 21 switches, at the time of obtaining the still image, the frame rate to the second frame rate, which is a frame rate higher than the first frame rate, and it makes an image with a short exposure time in accordance with the switching, to be obtained. This enables the imaging controlling section 21a to suppress the image blur. Further, the image processing section 14 adds respective pixel values at the same coordinate in the plurality of images obtained at the second frame rate, thereby generating a still image with a more favorable exposure. Specifically, the image processing section 14 can generate one still image in which the image blur is suppressed and a correct exposure is provided.

Further, generally, when a plurality of images are superimposed, a component of random noise included in the image is known to become 1/(n·½). For example, when the image processing section 14 superimposes four images to generate one image, the component of random noise becomes 1/(4·½)=½, and is suppressed to half.

Step S203: The CPU 21 records the still image generated by the image processing section 14 in the RAM 13. Subsequently, the CPU 21 terminates the processing of the subroutine illustrated in FIG. 7.

As described above, in the electronic camera 1 of the present embodiment, when the still image for recording is obtained during the moving image photographing, it is possible to obtain the still image with the more favorable exposure while suppressing the image blur. Further, in the electronic camera 1 of the present embodiment, even in a case where the still image is obtained during the moving image photographing, the moving image is interpolated, which prevents the occurrence of frame omission of the moving image.

<Supplemental Matters to Embodiment>

(1) In the present embodiment, the calculating section 21c calculates the number of images to be synthesized of the images at the second frame rate required for generating the still image. Here, explanation will be made on processing in a case where the number of images to be synthesized calculated for the still image generation is not the number which is n times (n is a natural number) the reference number of images used for the frame synthesis.

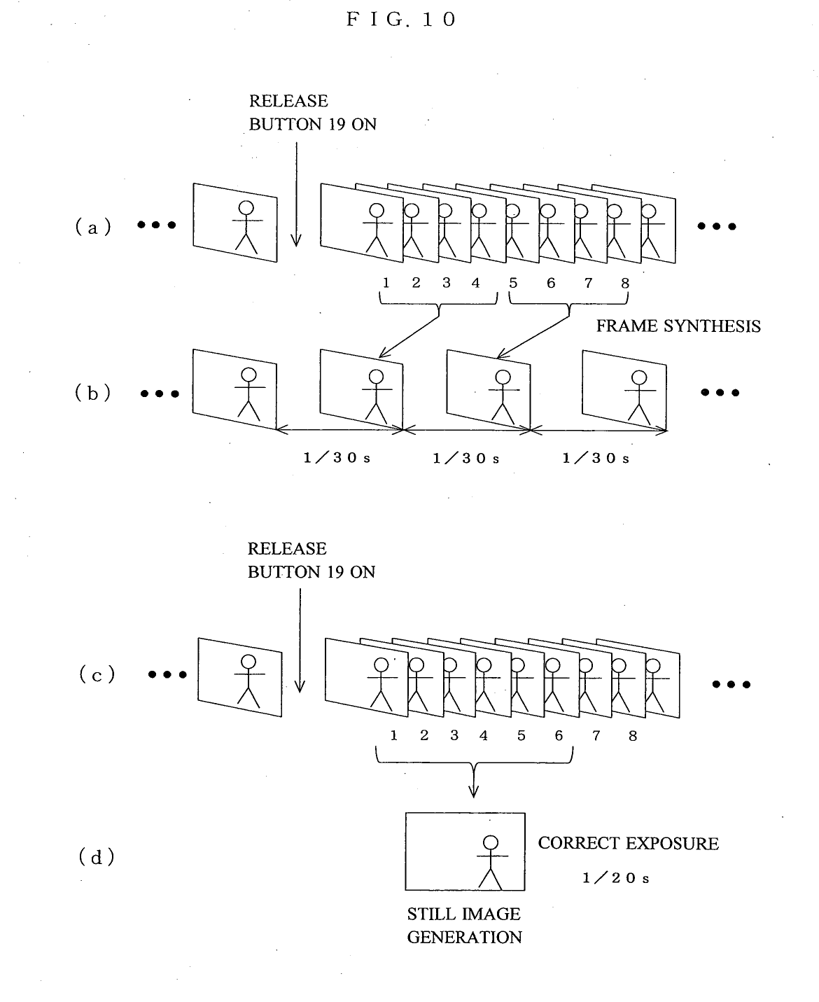

FIG. 10 is diagrams schematically explaining another example in the processing of still image generation and frame synthesis. For example, it is assumed that the shutter speed deciding section 21b decides the shutter speed which is 1/20 (second). In this case, based on a relation of 1/120 (second)×6= 1/20 (second), the number of images to be synthesized is six. Further, the reference number of images used for the frame synthesis is four, as described above.

Accordingly, the imaging controlling section 21a makes the imaging sensor 10 obtain eight (the number of images to be photographed) images at the second frame rate. (a) of FIG. 10 is a diagram explaining the frame synthesis, and, in the drawing, sequence numbers 1 to 8 represent an image group photographed at the second frame rate. In this case, the image processing section 14 synthesizes an image group from the sequence numbers 1 to 4 into one image, and it also synthesizes an image group from the sequence numbers 5 to 8 into one image. (b) of FIG. 10 represents a state where a moving image at the first frame rate is interpolated by a frame synthesized in accordance with the time interval of 1/30 (second).

Meanwhile, in the still image generation, the image processing section 14 superimposes an image group from the sequence numbers 1 to 6 to generate one still image, as illustrated in FIG. 10. The reason thereof is because, when the image processing section 14 generates one still image by superimposing the image group from the sequence numbers 1 to 8, the exposure amount becomes excessive. Accordingly, the electronic camera 1 can obtain a still image with a correct exposure, and at the same time, the frame omission of the moving image caused by the obtainment of the still image is prevented from occurring.

(2) In the present embodiment, it is also possible to design such that, at the time of generating the still image, the image processing section 14 increases a resolution of the still image, compared to a resolution of the frame of the moving image. For example, at the time of recording the moving image, the CPU 21 makes image signals to be read by thinning out pixels of the imaging sensor 10, in step S102 in FIG. 4. On the other hand, at the time of obtaining the still image, the CPU 21 makes image signals of all pixels of the imaging sensor 10 to be read, in step S106 and step S108. Further, the image processing section 14 performs the frame synthesis based on the thinned-out image signals. Further, the image processing section 14 generates a still image with high resolution based on the image signals of all of the pixels, at the time of generating the still image. Accordingly, the image processing section 14 can increase the resolution of the still image in step S110.

(3) The present embodiment may also further include a face detecting section detecting an area of a face from an image, and a feature amount extracting section extracting a feature amount of the face from the area of the face. Accordingly, the face detecting section detects the face, and the feature amount extracting section extracts the feature amount of the face. Further, the image processing section 14 may also be designed to generate a still image so as to correct a displacement of the face based on the feature amount. Accordingly, even if an image blur of a face or the like occurs between images at the second frame rate, the image blur is suppressed.

(4) In the present embodiment, the electronic camera of single lens reflex type is exemplified as the electronic camera, but, it is also possible to employ a compact-type electronic camera.

(5) In the present embodiment, the first frame rate is set to 30 fps, and the second frame rate is set to 120 fps, but, this is only an example, and, it is also possible that the first frame rate is set to 30 fps, and the second frame rate is set to 240 fps, for example.

(6) The present embodiment explains that the photographing is conducted at 1/30 second of shutter speed when performing imaging at the first frame rate (30 fps). However, when performing imaging at the first frame rate, the frame rate and the shutter speed do not always have to be matched. For example, when performing imaging at a predetermined frame rate (30 fps, for example), it is possible to appropriately use a shutter speed in a range which does not exceed the predetermined frame rate (the imaging may be performed at any ( 1/60 second, for example) shutter speed, as long as the shutter speed is faster than 1/30 second). In this case, in a similar manner that the above-described shutter speed deciding section 21b decides the shutter speed at the time of photographing the still image based on the brightness of the image obtained at the first frame rate, the shutter speed at the time of performing imaging at the first frame rate is also decided, based on brightness information of the subject, in a range that does not exceed the first frame rate.

The many features and advantages of the embodiment are apparent from the detailed specification and, thus, it is intended by the appended claims to cover all such features and advantages of the embodiment that fall within the true spirit and scope thereof. Further, since numerous modifications and changes will readily occur to those skilled in the art, it is not desired to limit the inventive embodiment to the exact construction and operation illustrated and described, and accordingly all suitable modifications and equivalents may be restored to, falling within the scope thereof.

What is claimed is:

1. An electronic camera, comprising:
an imaging section performing imaging of a subject image;
an imaging controlling section making the imaging section perform a photographing of moving image at a first frame rate at a time of performing moving image photographing, and making the imaging section obtain images at a second frame rate which is a frame rate higher than the first frame rate when receiving an instruction of still image recording at the time of performing the moving image photographing; and
an image processing section generating a still image for recording by superimposing a plurality of images at the second frame rate.

2. The electronic camera according to claim 1, wherein
the image processing section superimposes a plurality of images obtained at the second frame rate in accordance with a time interval of the first frame rate to convert the images into a moving image at the first frame rate.

3. The electronic camera according to claim 1, further comprising:
a deciding section deciding a shutter speed at a time of obtaining the still image based on a brightness of the image obtained at the first frame rate; and
a calculating section calculating a number of synthesized images at the second frame rate required for generating the still image based on the shutter speed, wherein
the image processing section generates the still image by superimposing the images whose number corresponds to the number of synthesized images obtained at the second frame rate.
